(19) United States
(12) Patent Application Publication
(10) Pub. No.: US 2020/0236954 A1
(43) Pub. Date: Jul. 30, 2020

(54) Foodstuff Grinder Kit for Stand Mixer

(71) Applicant: Hamilton Beach Brands, Inc., Glen Allen, VA (US)

(72) Inventors: Mark K Romandy, Midlothian, VA (US); Drew Carlson, Midlothian, VA (US)

(21) Appl. No.: 16/259,083

(22) Filed: Jan. 28, 2019

(51) Int. Cl. A22C 17/00; A47J 43/07

(52) U.S. Cl. CPC A22C 17/0026; A47J 43/0711

(57) ABSTRACT

A foodstuff grinder attachment kit includes: a lower tray including a plurality of receptacles; a grinder housing positioned in a first one of the receptacles, the grinder housing including a feed tube, a main body, and a conveyor configured to convey a foodstuff from the feed tube to an opening in the main body; and a feed tray having a feed exit, the feed tray configured to engage and overlie the lower tray to provide a cover for the kit.

### FIELD OF THE INVENTION

The present application is directed generally to mixers, and more particularly to stand mixers.

### BACKGROUND

Stand mixers are popular home appliances used for multiple tasks in combining ingredients, such as mixing, creaming, blending, and the like. Stand mixers typically include a base that supports a bowl, an upright support arm that extends upwardly from the base, and a cantilevered “head” that extends horizontally from the upright support on which beaters are mounted. The beaters extend downwardly from the arm into the bowl for use.

Some stand mixers are configured such that one or more accessories may be attached to the free end of the head and coupled to the drive train that drives the mixers. Exemplary accessories include meat grinders, pasta presses, and the like. Typically, the accessory is coupled to the head by removing a cover panel on the front end of the head, then inserting the drive end of the accessory into the head and coupling it with the drive train. An exemplary meat grinder that attaches to a stand mixer head is Model No. 226, available from Hamilton Beach Brands (Richmond, Va.).

It may be desirable to provide different functionality to accessories associated with stand mixers.

### SUMMARY

As a first aspect, embodiments of the invention are directed to a foodstuff grinder attachment kit, comprising: a lower tray including a plurality of receptacles; a grinder housing positioned in a first one of the receptacles, the grinder housing including a feed tube, a main body, and a conveyor configured to convey a foodstuff from the feed tube to an opening in the main body; and a feed tray having a feed exit, the feed tray configured to engage and overlie the lower tray to provide a cover for the kit.

As a second aspect, embodiments of the invention are directed to a method of preparing a kitchen appliance to grind a foodstuff comprising the steps of:

(a) providing a foodstuff grinder storage kit that includes:

a lower tray including a plurality of receptacles;

a grinder housing positioned in a first one of the receptacles, the grinder housing including a feed tube, a main body, and a conveyor configured to convey a foodstuff from the feed tube to an opening in the main body; and

a feed tray having a feed exit, the feed tray engaging and overlying the lower tray to provide a cover for the kit;

(b) disengaging the feed tray from the lower tray;

(c) removing the grinder housing from the lower tray;

(d) coupling the grinder housing on a stand mixer; and

(e) mounting the feed tray atop the feed tube of the grinder housing via the feed exit.

As a third aspect, embodiments of the invention are directed to a method of raising a bowl of a stand mixer comprising: a storage case for a foodstuff grinder attachment, comprising: a lower tray including a plurality of receptacles for receiving components of a foodstuff grinder; and a feed tray having a feed exit, the feed tray including a main panel and surrounding walls that extend in a first direction generally normal to the main panel, wherein the feed exit extends from the main panel in a direction generally opposite of the first direction, wherein the walls of the feed tray engages the lower tray and the main panel of the feed tray overlies the lower tray to provide a cover for the storage case.

### BRIEF DESCRIPTION OF THE FIGURES

FIG. 1 is a perspective view of a stand mixer according to embodiments of the invention.

FIG. 2 is a side view of the stand mixer of FIG. 1.

FIG. 3 is a front view of the stand mixer of FIG. 1.

FIG. 4 is a perspective view of a meat grinder attachment coupled to the stand mixer of FIG. 1.

FIG. 5 is a side view of the meat grinder attachment and stand mixer of FIG. 4.

FIG. 6 is a top view of the meat grinder attachment and stand mixer of FIG. 4.

FIG. 7 is a perspective view of a storage case for the meat grinder attachment of FIG. 4, with the lid in place.

FIG. 8 is a perspective view of the storage case of FIG. 7 with the cover removed.

FIG. 9 is a section view of the grinder housing showing the auger that resides within the cavity of the main body.

FIG. 10 is a section view of the feed tray of the meat grinder attachment of FIG. 4.

FIG. 11 is a section view of the feed nozzle of the meat grinder attachment of FIG. 4.

### DETAILED DESCRIPTION

The present invention will now be described more fully hereinafter, in which embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art. In the drawings, like numbers refer to like elements throughout. Thicknesses and dimensions of some components may be exaggerated for clarity.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein the expression “and/or” includes any and all combinations of one or more of the associated listed items.

In addition, spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. The device may be otherwise oriented (rotated 90 degrees or at other orientations) and the spatially relative descriptors used herein interpreted accordingly.

Well-known functions or constructions may not be described in detail for brevity and/or clarity.

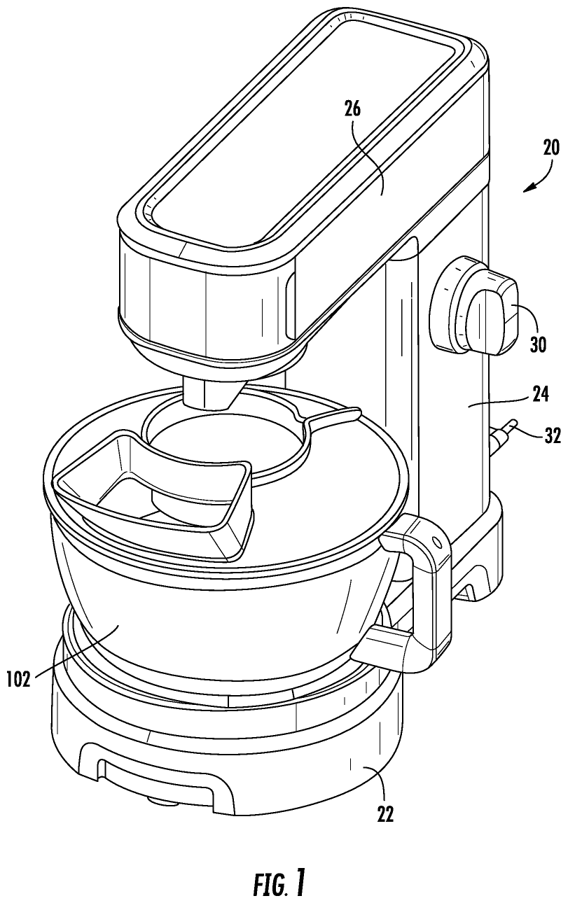

Referring now to the figures, a stand mixer according to embodiments of the invention is shown in FIGS. 1-3 and designated broadly at 20. The stand mixer 20 includes a base 22 that rests on an underlying surface, such as a kitchen counter, a vertical support arm 24 that extends upwardly from one end of the base 22, and a head 26 that extends generally horizontally and forwardly from the upper end of the support arm 24. (As used herein, the “forward” or “front” direction is defined by a horizontal vector extending from the support 24 toward the opposite end of the base 22. The “rear” direction is opposite the forward direction).

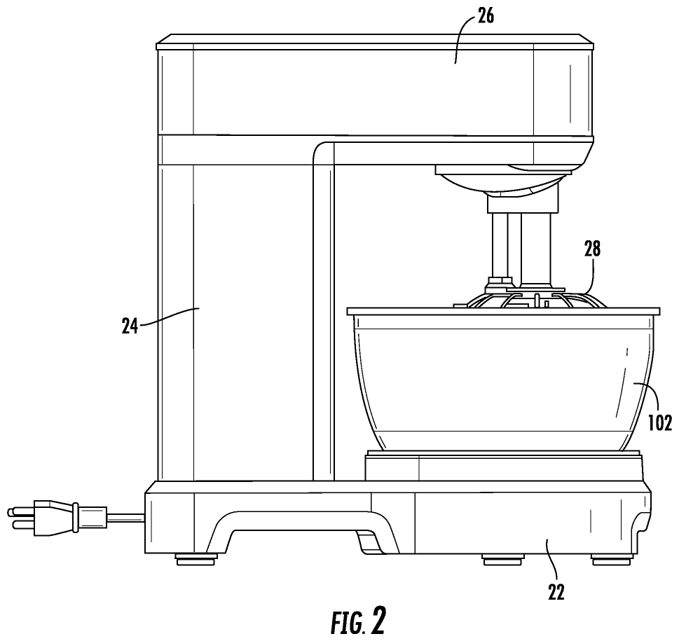

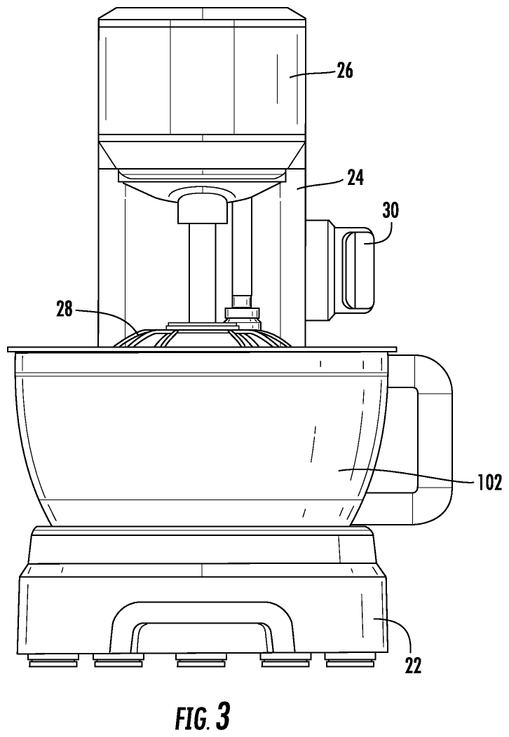

A pair of beaters 28 (seen best in FIGS. 2 and 3) is mounted near the forward end of the head 26. The beaters 28 are connected to a motor (not shown) mounted in the head 26 via a planetary gear arrangement that enables the beaters 28 to thoroughly mix ingredients within a bowl 102 (see below) mounted on the base 22 without scraping the sides or the bottom of the bowl 102. In such an arrangement, each of the beaters 28 rotates about an axis defined by its shaft, plus the pair of beaters 28 revolves together about an axis centered over the bowl 102 (described in detail below). The planetary gear arrangement can be any of those known to those of skill in this art (see, for example, U.S. Pat. No. 5,934,802) and need not be described in detail herein.

A dial 30 that regulates the speed of the beaters 28 is mounted on one side wall 24a of the support arm 24. The dial 30 is electrically connected with the motor in a conventional manner. A power cord 32 electrically connected with the motor is routed from the rear of the base 22.

Additional detail regarding the stand mixer 20 is set forth in U.S. patent application Ser. No. 15/952,882, filed Apr. 13, 2018, the disclosure of which is hereby incorporated herein in its entirety.

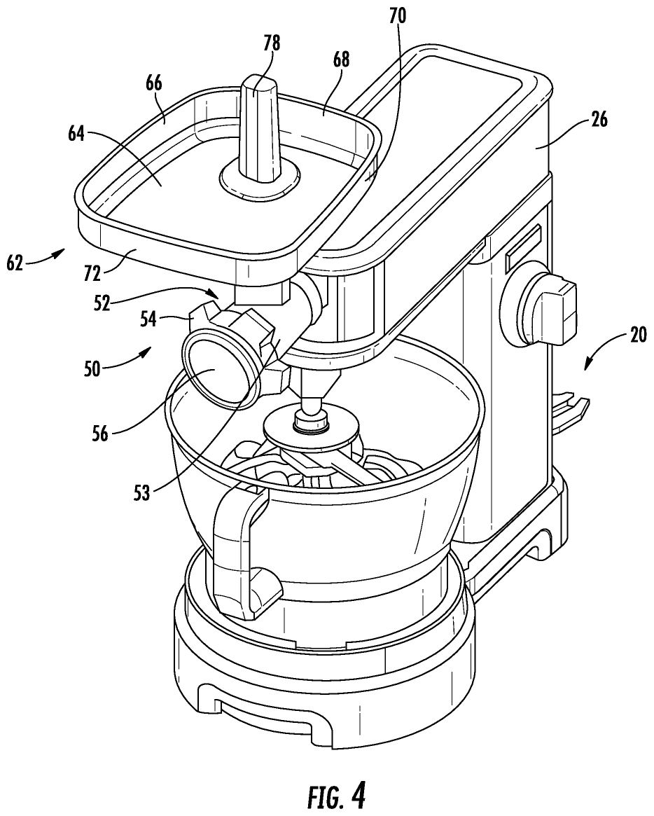

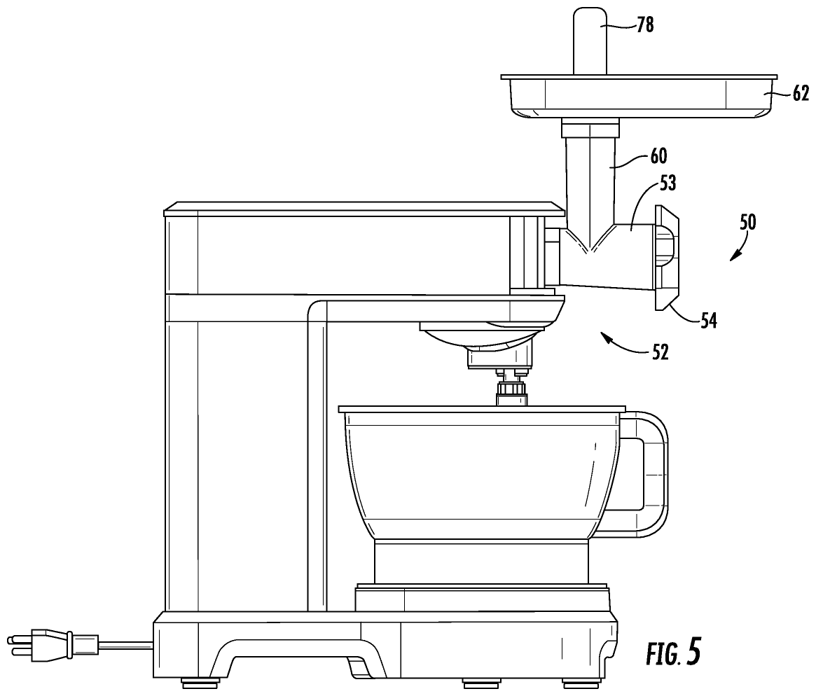

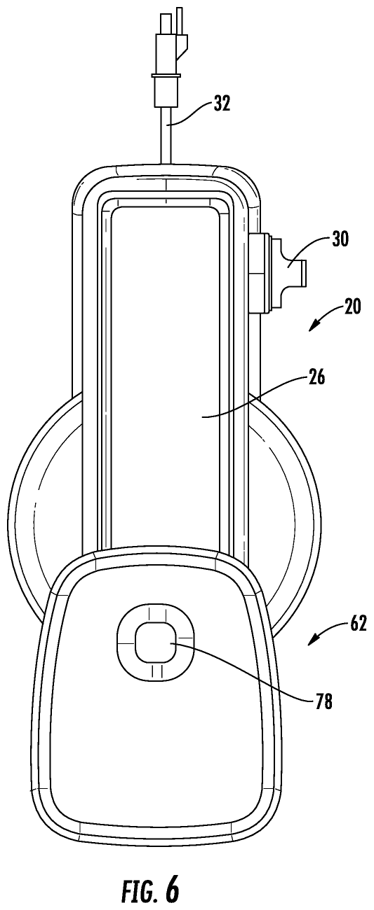

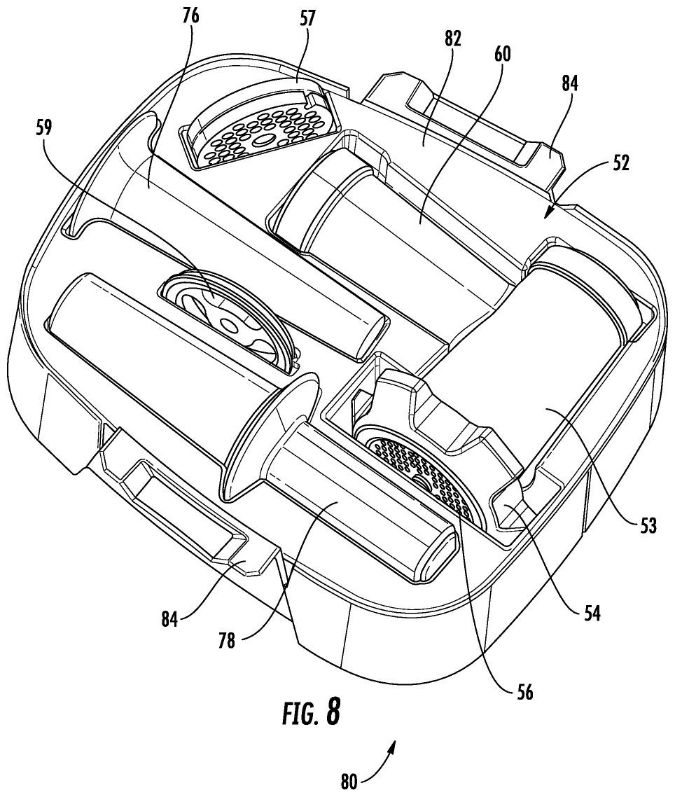

Referring now to FIGS. 4-6 and 9, a meat grinder attachment, designated broadly at 50, is attached to the head 26 of the stand mixer 20. The meat grinder attachment 50 includes a grinder housing 52 (typically formed of a metallic material) with a frustoconical main body 53 that couples to the drive train (not shown) of the stand mixer 20. An auger 55 (FIG. 9) extends longitudinally within the main body 53 and is attached to the drive train, such that rotation of the drive train rotates the auger 55. A large nut 54 is threaded onto the wider end of the main body 53. The nut 54 secures a sizing disk 56 onto the main body 53. The grinder housing 52 also includes a feed tube 60 that extends upwardly from the narrower end of the main body 52 opposite the nut 54.

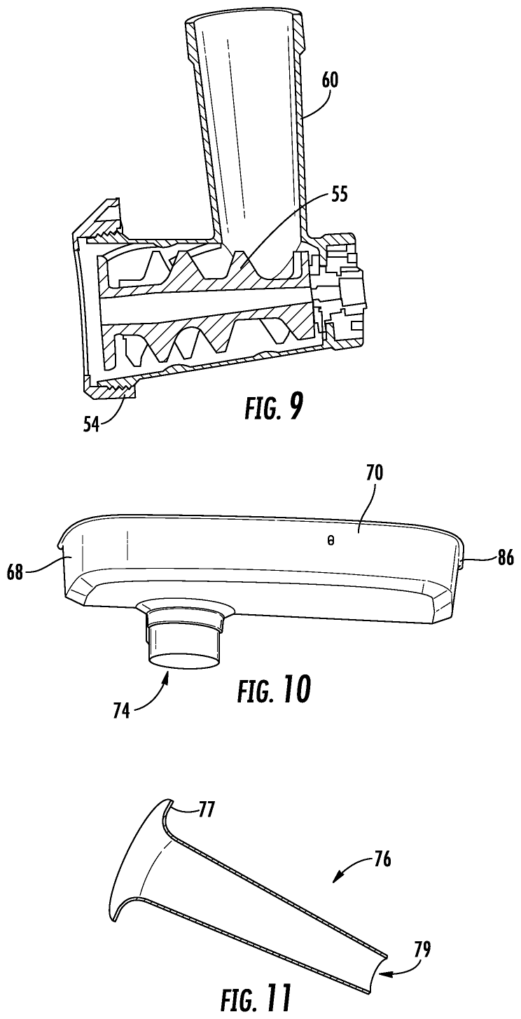

Referring still to FIGS. 4-6 and 10, a feed tray 62 is mounted atop the feed tube 60. The feed tray 62 includes a bottom panel 64 and walls 66, 68, 70, 72 that form a perimeter barrier around the bottom panel 64; a rim 86 is routed along the edges of the walls 66, 68, 70, 72. The bottom panel 64 is generally rectangular, but is slightly narrower at the end defined by wall 68. A round feed exit 74 is open at both ends and extends downwardly from and normal to the bottom panel 64. In the illustrated embodiment, the feed exit 74 is located somewhat off-center, nearer the narrower end of the main panel 62. In some embodiments, the feed tray 62 is formed of a metallic material.

The feed tray 62 is mounted to the feed tube via a feed nozzle 76 (see FIG. 11). The feed nozzle 76 (typically formed of a polymeric material) is open at both ends and is generally frustoconical, with a lip 77 extending radially outwardly at the wider end. The narrow end 79 of the feed nozzle 76 is inserted into the open upper end of the feed tube 60, such that the lip 78 rests on the upper edge of the feed tube 60. The feed exit 74 of the feed tray 62 is then inserted into the wider end of the feed nozzle 76.

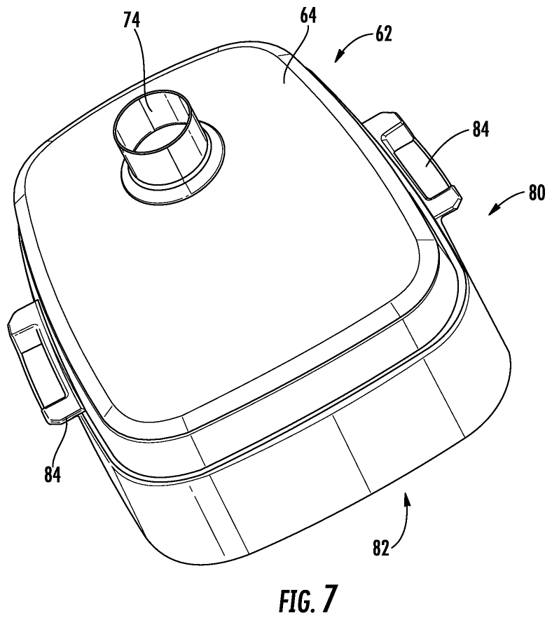

In operation, meat is placed on the feed tray 62 and is fed through the feed exit 74 into the feed nozzle 76. The meat drops (or is pushed with a pusher rod 78—see FIG. 8) down the feed nozzle 76 onto the auger 55. The drive train of the mixer 20 rotates the auger 55, which rotation conveys the meat to the wider end of the main body 53 of the grinder housing 52. The continued rotation of the auger 55 forces the meat through holes in the sizing disk 56 and out of the grinder housing 52, where it can be collected in a bowl or other vessel.

As shown in FIGS. 7 and 8, the meat grinder attachment 50 can be provided as a kit 80 that conveniently stores the various components thereof in a single container. As can be seen best in FIG. 8, the kit 80 includes a lower tray 82 (typically formed of a polymeric material) that includes receptacles shaped to receive the grinder housing 52, the feed nozzle 76, the pusher rod 78, and two additional sizing disks 57, 59 (the three sizing disks 56, 57, 59 have openings of different sizes to produce ground meat of varying coarseness). The lower tray 82 also includes two clips 84 on opposite sides.

As can be seen in FIG. 7, the feed tray 62 functions as a cover for the kit 80. A rim 86 is present on the edges of the walls 66, 68, 70, 72. As shown in FIG. 7, the feed tray 62 is positioned upside down (i.e., with the main panel 62 raised and the rim 86 lowered) above the lower tray 82 and pressed downwardly, so that the rim 86 slips under the upper ends of the clips 84 on the lower housing 82. The clips 84 maintain the feed tray 62 in position as a cover for the kit 80. For use, the feed tray 62 is removed, thereby permitting access to the other components of the meat grinder attachment 50.

It can be seen that the meat grinder attachment 50 can be provided in a convenient kit form for use. Additionally, the employment of the feed tray 62 as both the cover for the kit 80 and the feed tray when the meat grinder attachment 50 is in use can reduce the number of parts needed for the kit 80 and can reduce the overall size of the kit 80.

Those of skill in this art will appreciate that the various components discussed herein may take different configurations. The stand mixer 20 may take different forms; while it is typical that the stand mixer provide an attachment location at the free of the head, other possible attachment locations may be suitable.

As another alternative, the kit 80 may include different components. For example, more or fewer sizing disks may be included. The kit 80 may lack a feed nozzle 76 and simply rely on the feed tube 60 to convey the meat to the main body 53 of the grinder housing 52. The kit 80 may also include more than one type of pusher rod 78, or may include no pusher rods. The grinder housing 52 may be sized or configured differently. The sizing disks may be attached to the grinder housing 52 in a different manner. The grinder housing 52 may employ a different variety of conveyor in place of the auger 55. Other alternatives may also be suitable.

Moreover, the feed tray 62 may be configured differently. It may be shallower or deeper as desired, and/or the walls may define a footprint of different size or shape. The location of the feed exit 74 may vary. Also, the feed tray 62 may be attached to the lower tray 82 via means other than the clips 84 engaging the rim 86; for example, the feed tray 62 may be “press-fit” into place, the rim 86 may fit in channels or hooks in the lower housing 82, or clips or the like may be present on the feed tray 62 and engage a recess in the lower housing.

Further, although the meat grinder attachment 50 is shown herein, attachments for other foodstuffs, such as vegetables, fruit, and the like, may also be attached to the stand mixer 20 as an accessory and stored within a kit having a lower tray and a feed tray that serves as the cover for the kit.

The foregoing is illustrative of the present invention and is not to be construed as limiting thereof. Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

That which is claimed is:

1. A foodstuff grinder attachment kit, comprising:
a lower tray including a plurality of receptacles;
a grinder housing positioned in a first one of the receptacles, the grinder housing including a feed tube, a main body, and a conveyor configured to convey a foodstuff from the feed tube to an opening in the main body; and
a feed tray having a feed exit, the feed tray configured to engage and overlie the lower tray to provide a cover for the kit.

2. The kit defined in claim 1, further comprising a feed disk positioned in a second one of the receptacles.

3. The kit defined in claim 2, further comprising a pusher rod positioned in a third one of the receptacles.

4. The kit defined in claim 3, further comprising a feed nozzle positioned in a fourth one of the receptacles.

5. The kit defined in claim 1, wherein the lower tray includes a pair of clips that engage the feed tray to maintain the feed tray overlying the lower tray.

6. The kit defined in claim 1, wherein the feed tray includes a main panel and surrounding walls that extend in a first direction generally normal to the main panel.

7. The kit defined in claim 6, wherein the feed exit extends from the main panel in a direction generally opposite of the first direction.

8. A method of preparing a kitchen appliance to grind a foodstuff, comprising the steps of:
(a) providing a foodstuff grinder storage kit that includes:
a lower tray including a plurality of receptacles;
a grinder housing positioned in a first one of the receptacles, the grinder housing including a feed tube, a main body, and a conveyor configured to convey a foodstuff from the feed tube to an opening in the main body; and
a feed tray having a feed exit, the feed tray engaging and overlying the lower tray to provide a cover for the kit;
(b) disengaging the feed tray from the lower tray;
(c) removing the grinder housing from the lower tray;
(d) coupling the grinder housing on a stand mixer; and
(e) mounting the feed tray atop the feed tube of the grinder housing via the feed exit.

9. The method defined in claim 8, wherein the foodstuff comprises meat.

10. The method defined in claim 8, further comprising the step of inserting a feed nozzle into the feed tube of the grinder housing, and wherein step (e) comprises mounting the feed tray onto the feed nozzle.

11. The method defined in claim 8, wherein the kit further includes a pusher rod positioned in a second one of the receptacles, and further comprising the step of pushing a foodstuff on the feed tray through the feed exit and into the feed tube with the pusher rod.

12. The method defined in claim 8, wherein the lower tray includes a pair of clips that engage the feed tray to maintain the feed tray overlying the lower tray, and wherein step (b) comprising disengaging the feed tray from the clips.

13. The method defined in claim 8, wherein the feed tray includes a main panel and surrounding walls that extend in a first direction generally normal to the main panel, and wherein the feed exit extends from the main panel in a second direction generally opposite of the first direction.

14. A storage case for a foodstuff grinder attachment, comprising:
a lower tray including a plurality of receptacles for receiving components of a foodstuff grinder; and
a feed tray having a feed exit, the feed tray including a main panel and surrounding walls that extend in a first direction generally normal to the main panel, wherein the feed exit extends from the main panel in a direction generally opposite of the first direction, wherein the walls of the feed tray engages the lower tray and the main panel of the feed tray overlies the lower tray to provide a cover for the storage case.

15. The storage case defined in claim 14, wherein the lower tray includes a pair of clips that engage the feed tray to maintain the feed tray overlying the lower tray.

16. The storage case defined in claim 14, wherein the feed exit is generally round and configured to be received in the feed tube of a grinder housing.
